(19) United States
(12) Patent Application Publication
(10) Pub. No.: US 2002/0149804 A1
(43) Pub. Date: Oct. 17, 2002

(54) Method and apparatus for cleaning the underside of scanner platen

(76) Inventors: John Adam Mick, Fort Collins, CO (US); Jeremy L. Cook, Fort Collins, CO (US); John Mark Carleton, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/835,211

(22) Filed: Apr. 13, 2001

(51) Int. Cl. H04N 1/04

(52) U.S. Cl. 358/474

(57) ABSTRACT

A scanner apparatus comprises a housing having a transparent platen provided thereon. A wiper mounted within the housing is moveable along a displacement path and contacts the back surface of the transparent platen as the wiper is moved along the displacement path. A drive system operatively associated with the wiper moves the wiper along the displacement path so that the wiper removes accumulated debris from the back surface of the transparent platen as the wiper is moved along the displacement path.

### FIELD OF INVENTION

This invention relates to optical scanner devices in general and more specifically to a method and apparatus for cleaning the underside of the scanner platen.

### BACKGROUND

Scanner devices, such as flatbed scanners, are well-known in the art and produce machine-readable image data signals that are representative of a scanned object, such as a photograph or a page of printed text. In a typical scanner application, the image data signals produced by a scanner may be used by a personal computer to reproduce an image of the scanned object on a suitable display device, such as a CRT or a printer.

A typical flatbed scanner may include illumination and optical systems to accomplish scanning of the object. The illumination system illuminates a portion of the object (commonly referred to as a “scan region”), whereas the optical system collects light reflected by the illuminated scan region and focuses a small area of the illuminated scan region (commonly referred to as a “scan line”) onto the surface of a photosensitive detector provided within the scanner. Image data representative of the entire object then may be obtained by sweeping the scan line across the entire object, usually by moving the illumination and optical systems with respect to the object.

By way of example, the illumination system may include a light source (e.g., a fluorescent or incandescent lamp or an array of light emitting diodes (LEDs)). The optical system may include a lens and/or mirror assembly to focus the image of the illuminated scan line onto the surface of the detector. Alternatively, a “contact image sensor” (CIS) may be used to collect and focus light from the illuminated scan region onto the detector.

The photosensitive detector used to detect the image light focused thereon by the optical system may be a charge-coupled device (CCD), although other devices may be used. A typical CCD may comprise an array of individual cells or “pixels,” each of which collects or builds-up an electrical charge in response to exposure to light. Since the quantity of the accumulated electrical charge in any given cell or pixel is related to the intensity and duration of the light exposure, a CCD may be used to detect light and dark spots of an image focused thereon.

One problem associated with flatbed scanners of the type just described relates to the gradual accumulation of dirt and debris on the transparent platen of the scanner. While such dirt and debris accumulates most rapidly on the front side of the transparent platen, it also tends to accumulate on the underside of the transparent platen as well. That is, the housings of most flatbed scanners do not completely seal the interior portions of the scanners from the external environment. Consequently, there is a tendency for the undersides of the transparent platens of such scanners to gradually accumulate dirt and debris from the external environment. Of course, the accumulation of such dirt and debris can degrade image quality.

While such accumulated dirt and debris may be easily removed from the front side of the transparent platen by the user (e.g., by periodically cleaning the front side of the transparent platen with a towel or rag), it is generally considerably more difficult to clean the underside of the transparent platen. That is, the transparent platens of most flatbed scanners are not designed to be removed by the user. Consequently, most scanner users are not able to clean the underside of the platen glass, even though the underside may become contaminated with dirt and debris to the point where it adversely affects image quality.

### SUMMARY OF THE INVENTION

Scanner apparatus according to the present invention comprises a housing having a transparent platen provided thereon. A wiper mounted within the housing is moveable along a displacement path and contacts the back surface of the transparent platen as the wiper is moved along the displacement path. A drive system operatively associated with the wiper moves the wiper along the displacement path so that the wiper removes accumulated debris from the back surface of the transparent platen as the wiper is moved along the displacement path.

Also disclosed is a method that comprises the steps of: Providing scanner apparatus having a transparent platen portion and a scanner device mounted within the scanner apparatus so that the scanner device is moveable along a displacement path; mounting a wiper on the scanner device so that the wiper contacts the transparent platen portion of the scanner apparatus as the scanner device is moved along the displacement path; and moving the scanner device to cause the wiper to clean the transparent platen.

### BRIEF DESCRIPTION OF THE DRAWING

Illustrative and presently preferred embodiments of the invention are shown in the accompanying drawing in which:

FIG. 1 is a perspective view of a flatbed scanner according to one embodiment of the present invention having a wiper positioned on the moveable carriage of the scanner;

FIG. 2 is a sectional view in elevation of the flatbed scanner shown in FIG. 1 more clearly showing the moveable carriage and drive system; and

FIG. 3 is an enlarged side view in elevation of the moveable carriage and wiper assembly illustrated in FIG. 2.

### DETAILED DESCRIPTION OF THE INVENTION

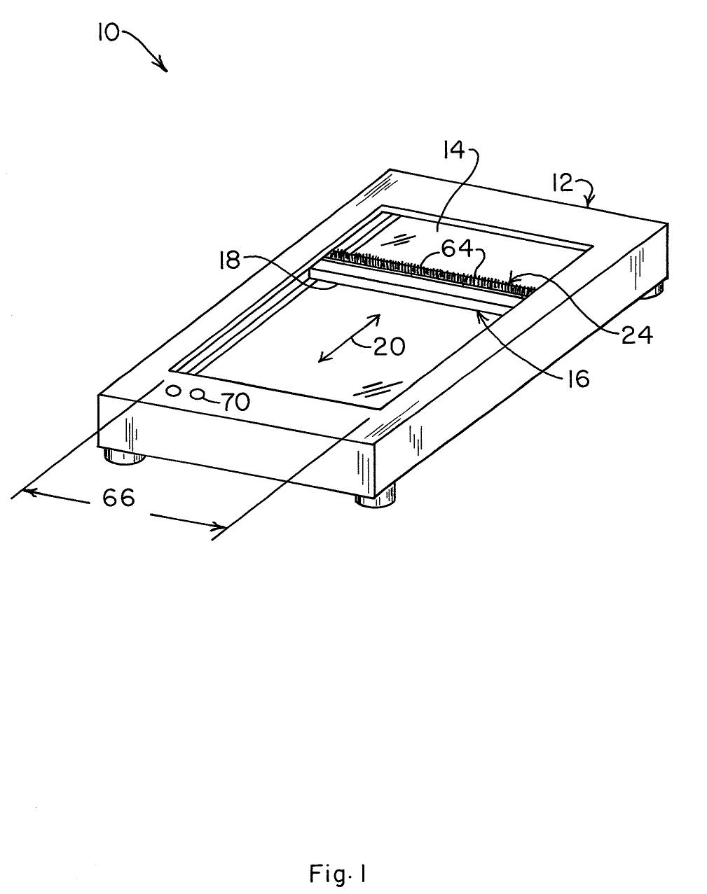

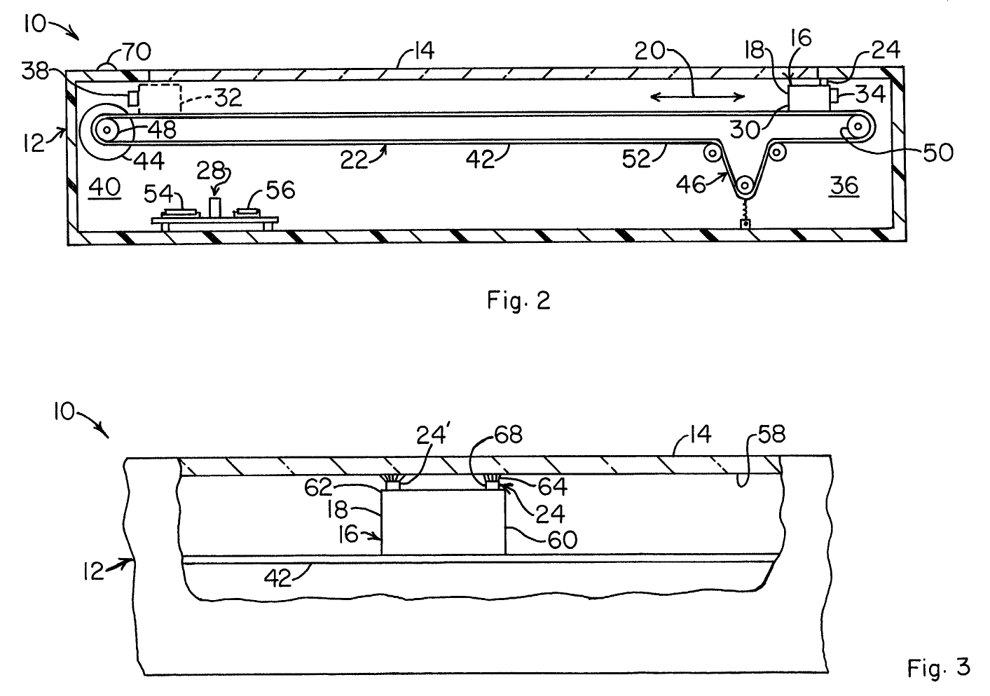

A flatbed scanner apparatus 10 according to one embodiment of the present invention is shown in FIG. 1 and may comprise a housing 12 having a transparent platen 14 provided thereon. The transparent platen 14 allows an object (not shown) positioned on the transparent platen 14 to be scanned by a scanner device 16 provided within the housing 12 of scanner apparatus 10. The scanner device 16 produces electronic image data signals (not shown) that are representative of the scanned object. In the embodiment shown and described herein, the scanner device 16 is mounted to a carriage 18 that is moveably mounted within the housing 12 so that the carriage 18, thus scanner device 16, is moveable back and forth underneath the transparent platen 14, generally along a displacement path 20. A drive system 22 (FIG. 2) operatively associated with the carriage 18 moves the carriage 18 back and forth underneath the transparent platen 14 (i.e., along the displacement path 20) to allow the scanner device 16 mounted on the carriage 18 to scan the object positioned on the transparent platen 14.

With reference now primarily to FIGS. 2 and 3, a wiper 24 is mounted to the carriage 18 so that the wiper 24 contacts the transparent platen 14 as the carriage 18 is moved back and forth along the displacement path 20. The wiper 24 removes any debris (not shown) that may have accumulated on the transparent platen 14, thereby maintaining the cleanliness of the underside of the transparent platen 14.

The flatbed scanner apparatus 10 according to the present invention may be operated as follows to clean the transparent platen 14. Assuming that the scanner apparatus 10 has been provided with a wiper 24 that is moveable back and forth underneath the transparent platen 14 (i.e., along the displacement path 20), the transparent platen 14 may be cleaned by simply operating the scanner apparatus 10 in order to scan a document or object (not shown) positioned on the transparent platen 14. As the carriage 18 (thus scanner device 16) is moved along the displacement path 20 by the drive system 22, the wiper 24 removes any debris (not shown) that may have accumulated on the transparent platen 14. That is, the transparent platen 14 is cleaned each time the carriage 18 and scanner device 16 are moved along the displacement path 20.

A significant advantage of the flatbed scanner apparatus 10 according to the present invention is that it cleans the underside of the transparent platen 14 each time the scanner apparatus 10 is operated to scan a document or object. Consequently, the underside of the transparent platen 14 is always maintained in a clean condition which significantly reduces the likelihood that dirt or debris will accumulate on the underside of the transparent platen 14 and possibly degrade or otherwise affect the quality of the image data produced by the scanner device 16. Moreover, since the present invention cleans the underside of the transparent platen 14 with each operation of the scanner 10, the user need not be concerned with maintaining the cleanliness of the underside of the transparent platen 14. Still yet another advantage of the present invention is that it may be easily implemented on existing flatbed scanner designs. In many cases, the present invention can be implemented on an existing flatbed scanner system without the need to modify or re-design the various components comprising the existing system.

Having briefly described the flatbed scanner apparatus 10 according to the present invention, as well as some of its more significant features and advantages, the various embodiments of the method and apparatus of the present invention will now be described in detail. However, before proceeding with the detailed description, it should be noted that the method and apparatus of the present invention may be utilized on any of a wide range of flatbed type scanner systems that are now known in the art or that may be developed in the future, as would be obvious to persons having ordinary skill in the art after having become familiar with the teachings of the present invention. Consequently, the present invention should not be regarded as limited to the particular type of flatbed scanner and to the particular applications shown and described herein.

With the foregoing considerations in mind, one embodiment of flatbed scanner apparatus 10 according to the present invention may comprise a generally rectangularly shaped housing or chassis 12 that is sized to receive the various systems and components of the flatbed scanner apparatus 10. For example, in the embodiment shown and described herein, the housing 12 defines a central aperture or opening 26 that is sized to receive the transparent platen 14. The housing 12 is also sized to receive the scanner device 16, the carriage assembly 18, and the drive system 22. The housing 12 may also be provided with a control system 28 that controls the function and operation of the various components of the flatbed scanner apparatus 10. Of course, the housing 12 of the scanner 10 may also be provided with a cover or lid (not shown) that is sized to cover the object positioned on the transparent platen 14 during the scanning operation.

The housing 12 of flatbed scanner apparatus 10 may be fabricated from any of a wide range of materials, such as metals or plastics, suitable for the intended application and expected environment in which the scanner 10 is to be used. However, since housings or chassis for flatbed type scanning systems are well-known in the art and could be readily provided by persons having ordinary skill in the art, the various features and attributes of the housing 12, as well as the various materials from which it may be manufactured, will not be described in further detail herein.

The transparent platen 14 of scanner apparatus 10 may comprise any of a wide range of transparent, plate-like materials suitable for being received within the central aperture 26 defined by the housing 12. By way of example, in one preferred embodiment, the transparent platen is fabricated from glass, although other materials may also be used. The transparent platen 14 may be secured within the central aperture 26 of housing 12 by any convenient fastening device or system (e.g., by mechanical fasteners or by an adhesive) well-known in the art. Here again, since the details of providing transparent platens to scanner housings are well-known in the art and are not necessary to understand or practice the present invention, the particular mounting arrangements utilized in one preferred embodiment of the invention will not be described in further detail herein.

The flatbed scanner apparatus 10 may be provided with a line-type scanner device 16 suitable for producing electronic image data that are representative of the scanned object. The scanner device 16 may comprise any of a wide range of line-type scanning devices that are well-known in the art or that may be developed in the future. Consequently, the present invention should not be regarded as limited to any particular type of scanning device. However, by way of example, in the embodiment shown and described herein, the scanner device 16 may comprise a conventional reflective-type system utilizing one or more reflective elements (e.g., mirrors) and a lens assembly to direct and focus image light onto a suitable detector. Alternatively, the scanner device 16 may comprise contact image sensor (CIS) having an integrated lens and detector assembly of the type that is well-known in the art and readily commercially available. The scanner device 16 may also comprise a light source (not shown) suitable for illuminating the scan line on the object being scanned. However, since such line-type scanner devices, such as scanner device 16, are well-known in the art and could be easily provided by persons having ordinary skill in the art after having become familiar with the teachings of the present invention, the particular scanner device 16 utilized in one preferred embodiment of the invention will not be described in further detail herein.

The scanner device 16 may be mounted within a carriage 18 that is moveably mounted within the housing 12 so that the assembly is free to move back and forth underneath the transparent platen 14 along a displacement path 20 between a home position 30 and an away position 32, as best seen in FIG. 2. It is generally preferred, but not required, that the housing 12 be provided with a home position travel stop 34 located at about the home position end 36 of housing 12 and an away position travel stop 38 located at an away position end 40 of housing 12. The home and away position stops 34 and 38 prevent the carriage 18 from being moved beyond the home and away positions 30 and 32, respectively. The carriage 18 may be moveably mounted within the housing 12 by a mounting system (not shown) suitable for allowing the carriage 18 to be moved along the displacement path 20 between the home and away positions 30 and 32. However, since mounting systems for the moveable carriages utilized in flatbed type scanners are well-known in the art and could be easily provided by persons having ordinary skill in the art, the particular mounting system utilized in one preferred embodiment of the present invention will not be described in further detail herein.

A drive system 22 operatively associated with the carriage 18 moves the carriage 18, thus scanner device 16, back and forth underneath the transparent platen 14 (i.e., along the displacement path 20) to accomplish scanning of the object. In the embodiment shown and described herein, the drive system 22 comprises an endless drive belt 42, a drive motor 44, and a drive belt tensioning system 46. Alternatively, other types of drive systems may be used. The drive belt 42 extends between a drive pulley or sprocket 48 provided on the drive motor 44 and an idler pulley or sprocket 50. The carriage 18 containing the scanner device 16 is operatively associated with the drive belt 42 so that movement of the drive belt 42 will cause the carriage 18 to move along the displacement path 20 between the home position 30 and the away position 32. The belt tensioning system 46 engages the lower loop portion 52 of the drive belt 42. The drive belt tensioning system 46 maintains a substantially constant tension on the drive belt 42, thereby allowing for the smooth operation of the same and also allowing the drive system 22 to accommodate normally expected production tolerances. However, since drive systems, such as drive system 22, for operating moveable carriages in flatbed scanners are well-known in the art and since the details of such drive systems are not necessary to understand or practice the present invention, the particular drive system 22 that may be utilized in the present invention will not be described in further detail herein.

The scanner device 16 and the drive system 22 are operatively associated with a control system 28 (FIG. 2) provided within the housing 12. The control system 28 controls the function and operation of the two systems. In the embodiment shown and described herein, the control system 28 is provided with an image data processing portion 54 and a drive system control portion 56. The image data processing portion 54 of control system 28 operates the scanner device 16 and processes the image data (not shown) produced by the scanner device 16. The image data processing portion 54 of control system 28 may be connected to the scanner device 16 provided on carriage 18 via a suitable connection or link (e.g., via “ribbon” cable, (not shown)) so that the image data processing portion 54 of control system 28 may operate the scanner device 16 and so that the electronic image data produced by the scanner device 16 may be collected and processed by the image data processing portion 54 of control system 28.

The drive system control portion 56 of control system 28 operates the various components and elements of the drive system 22. The drive system control portion 56 may be operatively connected to the various components of the drive system 22 via any of a wide range of suitable connections or links (e.g., via electrically conductive cables, etc.) well-known in the art or that may be developed in the future to allow the drive system control portion 56 of control system 28 to operate the drive system 22 to accomplish the scanning operation.

Since control systems, such as control system 28, for controlling the function and operation of flatbed type scanner systems are also well-known in the art and since the details of such systems are not required to understand or practice the present invention, the control system 28 that may be utilized in one preferred embodiment of the present invention will not be described in further detail herein.

With reference now primarily to FIG. 3, the scanner apparatus 10 of the present invention is provided with a wiper 24 mounted within the housing 12 of scanner 10 so that the wiper 24 is moveable back and forth underneath the transparent platen 14 (i.e., along the displacement path 20). The arrangement is such that the wiper 24 contacts a back side 58 of transparent platen 14 as the wiper 24 is moved back and forth underneath the transparent platen 14. Accordingly, the wiper 24 removes accumulated debris (not shown) on the back side 58 of transparent platen 14.

In one preferred embodiment, the wiper 24 is mounted to the carriage 18 of the scanner apparatus 10 so that the wiper 24 moves with the carriage 18 as the carriage 18 is moved along the displacement path 20 (i.e., between the home and away positions 30 and 32). Mounting the wiper 24 on the carriage 18 is advantageous in that it eliminates the need to provide a separate moveable mounting system for the wiper 24. However, other mounting arrangements are possible that would also fall within the scope of the present invention. For example, if the scanner device 16 does not include a separate carriage assembly, such as carriage assembly 18, but is instead directly moveably mounted within the housing 12 so that the scanner device 16 is moveable underneath the platen 14, the wiper 24 could be mounted directly to the scanner device 16. In this arrangement, the wiper 24 will move with the scanner device 16. In still another alternative arrangement, the wiper 24 could be separately moveably mounted within the housing 12. Since many different mounting arrangements for the wiper 24 are possible depending on the particular configuration of the flatbed scanner system in which the present invention is to be utilized, the present invention should not be regarded as limited to the particular mounting arrangements shown and described herein.

Continuing now with the description, it is generally preferred, but not required, that the wiper 24 be mounted at about the trailing side 60 of the carriage 18. See FIG. 3. The trailing side 60 of carriage 18 is that side of the carriage 18 that trails the movement of the carriage 18 as the carriage 18 is moved in the scanning direction, i.e., as the carriage 18 is moved from the home position 30 to the away position 32. That is, the trailing side 60 of the carriage 18 “trails” the movement of the scanner device 16 as the scanner device 16 is moved in the scan direction. By so mounting the wiper 24 on the trailing side 60 of the carriage 18, the wiper 24 contacts or wipes the entire area of the back side 58 of the transparent platen 14 that is interposed between the scanner device 16 and the object being scanned, provided, of course, that the carriage 18 overshoots or travels beyond the last scan line position at the away end 40 of the housing 18.

In another embodiment of the invention, a “leading” wiper 24′ could be mounted at about a leading side 62 of carriage 18. If such a leading wiper 24′ is mounted to the leading side 62 of carriage 18, the drive system 22 of scanner apparatus 10 should move the carriage 18 so that the carriage 18 overshoots or travels beyond the initial scan line position at the home end 36 of the housing 18. This will allow the wiper 24′ to wipe that area or portion of the underside 58 of transparent platen 14 that is interposed between the scanner device 16 and the object when the scanner device 16 is located at the initial scan line position. In still another embodiment, the carriage 18 may be provided with a first wiper (e.g., wiper 24) mounted at about the trailing side 60 of the carriage 18 and a second wiper (e.g., wiper 24′) mounted at about the leading side 62 of carriage 18. Such an arrangement would provide wiping of all those areas or portions of the underside 58 of transparent platen 14 that are interposed between the scanner device 16 and the object (not shown) being scanned without the need to configure the system so that the carriage 18 overshoots or travels beyond both the initial scan line position and the last scan line position.

The wiper (e.g., wiper 24 and/or 24′) may comprise any of a wide range of materials suitable for contacting and wiping clean the back side 58 of transparent platen 14. For example, in one preferred embodiment, the wiper 24 (or wipers 24 and 24′, if two wipers are used) may comprise a plurality of bristles 64. It is generally preferred that the plurality of bristles 64 comprising wiper 24 be arranged so that the bristles 64 extend along substantially the entire width 66 of transparent platen 14, as best seen in FIG. 1. Such an arrangement allows the bristles 64, thus wiper 24, to wipe the entirety of the area of the transparent platen 14 that is interposed between the scanner device 16 and the object being scanned.

The bristles 64 comprising the wiper 24 may comprise any of a wide range of materials having any of a wide range of sizes that would be suitable for wiping the back side 58 of transparent platen 14. Consequently, the present invention should not be regarded as limited to bristles 64 comprising any particular material or having any particular sizes. However, by way of example, in one preferred embodiment, the bristles 64 are formed from nylon. The bristles 64 may be attached to a suitable base member 68 by any of a wide variety of methods and/or processes (e.g., by over-molding) that are well-known in the art. The base member 68 may in-turn be mounted or affixed to the carriage 18 by any of a wide range of mounting systems and devices (e.g., mechanical fasteners or adhesives) well-known in the art.

In other embodiments of the invention, the wiper 24 may comprise any of a wide range of resilient materials suitable for contacting and wiping the back side 58 of transparent platen 14. For example, in another embodiment of the invention, the resilient material comprising the wiper 24 comprises a woolen felt material, although felt or felt-like materials made from synthetic materials may also be used.

The present invention may be operated as follows to clean the back side 58 of transparent platen 14. Assuming that a scanner apparatus 10 has been provided that includes the wiper 24 substantially as shown and described herein, the back side 58 of transparent platen 14 may be cleaned by operating the scanner apparatus 10 in order to scan a document or object (not shown) positioned on the transparent platen 14. As the carriage 18 is moved along the displacement path 20 by the drive system 22, the wiper 24 contacts the back side 58 of the transparent platen 14 and removes any debris (not shown) that may have accumulated on the back side 58 transparent platen 14. Accordingly, the transparent platen 14 is cleaned each time the carriage 18 (and scanner device 16) are moved along the displacement path 20.

Generally speaking, the method for cleaning the back side 58 of the transparent platen 14 will be accomplished each time the user activates the scanner apparatus 10 to perform a scanning operation in the manner already described. That is, the cleaning function will be initiated via the existing scanner software. However, other arrangements for performing the cleaning function are possible. For example, in another embodiment, the scanner apparatus 10 may be provided with a separate cleaning switch 70 (FIGS. 1 and 2). The cleaning switch 70 may be operatively associated with the control system 28 so that when the cleaning switch 70 is actuated, the control system 28 will operate the drive system 22. The drive system 22 then moves the carriage 18, thus wiper 24, from the home position 30 to the away position 32 in order to clean the back side 58 of the transparent platen 14. In this manner, the cleaning switch 70 allows the user to initiate the cleaning function without also performing a scanning operation.

It is contemplated that the inventive concepts herein described may be variously otherwise embodied and it is intended that the appended claims be construed to include alternative embodiments of the invention except insofar as limited by the prior art.

What is claimed is:

1. Scanner apparatus, comprising:
a transparent platen mounted to a housing, said transparent platen having a front surface and a back surface;
a wiper mounted within said housing so that said wiper is moveable along a displacement path and so that said wiper contacts the back surface of said transparent platen as said wiper is moved along the displacement path; and
a drive system operatively associated with said wiper, said drive system moving said wiper along the displacement path, said wiper removing accumulated debris from the back surface of said transparent platen as said wiper is moved along the displacement path.

2. The scanner apparatus of claim 1, wherein said wiper comprises a plurality of bristles.

3. The scanner apparatus of claim 1, wherein said wiper comprises a resilient material.

4. The scanner apparatus of claim 3, wherein said resilient material comprises felt.

5. The scanner apparatus of claim 1, wherein said transparent platen comprises a width and a length, wherein said wiper extends along the width of the transparent platen.

6. The scanner apparatus of claim 1, further comprising a scanner device mounted within said housing so that said scanner device is moveable along the displacement path, wherein said drive system is operatively associated with said scanner device and moves said scanner device along the displacement path, and wherein said wiper is mounted to said scanner device so that said wiper moves with said scanner device.

7. The scanner apparatus of claim 6, wherein said scanner device comprises a leading side and a trailing side and wherein said wiper is mounted to the trailing side of said scanner device.

8. The scanner apparatus of claim 6, wherein said scanner device comprises a leading side and a trailing side and wherein said wiper is mounted at about the leading side of said scanner device.

9. The scanner apparatus of claim 6, wherein said scanner device is mounted to a carriage, said carriage being mounted within said housing so that said carriage is moveable along the displacement path, said carriage being operatively associated with said drive system so that said drive system moves said carriage along the displacement path, and wherein said wiper is mounted to said carriage.

10. The scanner apparatus of claim 9, wherein said transparent platen has a length and a width, wherein said carriage extends along the width of said transparent platen, and wherein said wiper extends substantially along the width of said transparent platen.

11. The scanner apparatus of claim 10, wherein said wiper comprises a plurality of bristles.

12. The scanner apparatus of claim 10, wherein said wiper comprises a resilient material.

13. The scanner apparatus of claim 12, wherein said resilient material comprises felt.

14. Scanner apparatus, comprising:
a housing having a transparent platen portion;
a scanner device mounted within said housing so that said scanner device is moveable along a displacement path;
a drive system operatively associated with said scanner device, said drive system moving said scanner device along the displacement path; and
a first wiper mounted to said scanner device so that said first wiper contacts the transparent platen portion of said housing as said scanner device is moved along the displacement path, said first wiper removing accumulated debris from the transparent platen portion of said housing.

15. The scanner apparatus of claim 14, wherein said scanner device comprises a leading side and a trailing side and wherein said first wiper is mounted at about the trailing side of said scanner device.

16. The scanner apparatus of claim 15, further comprising a second wiper mounted at about the leading side of said scanner device.

17. The scanner apparatus of claim 16, wherein said first wiper comprises a plurality of bristles and wherein said second wiper comprises a plurality of bristles.

18. The scanner apparatus of claim 14, wherein said scanner device comprises a leading side and a trailing side and wherein said first wiper is mounted at about the leading side of said scanner device.

19. A method, comprising:
providing scanner apparatus having a transparent platen portion and a scanner device mounted within the scanner apparatus so that the scanner device is moveable along a displacement path; and
mounting a wiper on the scanner device so that the wiper contacts the transparent platen portion of the scanner apparatus as the scanner device is moved along the displacement path.

20. The method of claim 19, further comprising moving said scanner device along the displacement path, the wiper removing accumulated debris from the transparent platen portion as the scanner device is moved along the displacement path.
